(19) United States
(12) Patent Application Publication
(10) Pub. No.: US 2016/0350023 A1
(43) Pub. Date: Dec. 1, 2016

(54) RE-INITIALIZING MEMORY ARRAYS

(71) Applicant: HEWLETT PACKARD ENTERPRISE DEVELOPMENT LP, Houston, TX (US)

(72) Inventors: Gregg B. Lesartre, Fort Collins, CO (US); R. Stanley Williams, Portola Valley, CA (US); Gary Gibson, Palo Alto, CA (US)

(21) Appl. No.: 15/106,444

(22) PCT Filed: Jan. 28, 2014
(86) PCT No.: PCT/US2014/013376

§ 371 Date: Jun. 29, 2016

(51) Int. Cl. G06F 3/06

(52) U.S. Cl. CPC G06F 3/0632; G06F 3/0604; G06F 3/0616; G06F 3/0688

(57) ABSTRACT

A system for re-initializing a memory array is described. The system includes a processor and a memory array communicatively coupled to the processor. The system also includes a memory manager. The memory manager includes an establish module to establish a reference state for the memory array. The reference state includes a number of target resistance values for the memory array. The memory manager includes a write module to write data to the memory array. The memory manager includes a re-initialize module to re-initialize the memory array to the established reference state.

### BACKGROUND

Memory arrays are used to store data. A memory array may be made up of memory locations. Each memory location may be made up of memory bits. Data may be stored to memory arrays by setting values of the memory bits within the memory arrays. For example, the memory bits may be set to 0, 1, or combinations thereof to store data in a memory bit of a memory array.

### BRIEF DESCRIPTION OF THE DRAWINGS

The accompanying drawings illustrate various examples of the principles described herein and are a part of the specification. The illustrated examples do not limit the scope of the claims.

FIG. 1 is a diagram of a system for re-initializing memory arrays according to one example of the principles described herein.

FIG. 2 is a flowchart of a method for re-initializing memory arrays according to one example of the principles described herein.

FIG. 3 is a flowchart of another method for re-initializing memory arrays according to one example of the principles described herein.

FIG. 4 is a state diagram illustrating states of a memory array according to one example of the principles described herein.

FIGS. 5A and 5B are diagrams of a system for re-initializing arrays according to one example of the principles described herein.

FIG. 6 is a diagram of a memory manager for re-initializing memory arrays according to one example of the principles described herein.

Throughout the drawings, identical reference numbers designate similar, but not necessarily identical, elements.

### DETAILED DESCRIPTION

As described above, memory arrays may be used to store data by setting memory bit values within the memory array. For example, memory bits may be set to values such as 1 or 0 to effectively store data in the memory array. Memory arrays may be of varying types. For example, a memory array may use digital elements. In another example, a memory array may use analog elements. In this example, a memory array that uses analog elements may be referred to as an analog memory array.

With an analog memory array, a voltage pulse may be sent that writes a value, such as 0 or 1, to a memory bit within the memory array. For example, a voltage pulse may be sent to the analog memory array which pulse sets a memory bit within the memory array to a “low resistance” value. A low resistance value may be represented by the value 1. Similarly, a voltage pulse of a different polarity may be sent to the analog memory array which pulse sets a memory bit within the memory array to a “high resistance” value. A high resistance value may be represented by the value 0. However, the nature of analog memory elements within a memory array may complicate their use.

For example, analog memory elements may be subject to statistical variation in response to a polarity pulse that may cause a target resistance value of the memory bit to drift. Over time the statistical variation, or drift, may be such that a resistance value that corresponds to a bit may drift. In some cases the drift may be such that the bit isn't written correctly thus making the reading of the data uncertain. Moreover, even if a response was deterministic, the pulses may not be controlled to infinite precision. Accordingly, drift may result by inexact compensation of opposite polarity pulses after a certain number of writes. Additionally, many writes of the same polarity may cause a memory bit to be “overwritten” such that an accurate indication of a 1 or a 0 may not be possible. The values stored in memory bits within the same memory array may also cause variability in the pulse seen at the memory bit being written. Additionally, the response of memory elements to a given write pulse may vary depending on the number of times a memory bit has been written and erased.

Accordingly, certain procedures may be implemented to ensure the accuracy of bit writing. For example, a voltage pulse may be sent to an analog memory bit, which pulse is intended to write a value to a bit by setting the memory bit to a particular resistance value. Such a pulse may be referred to as a write pulse. The memory bit may then be read to determine whether the memory bit has a resistance value that corresponds with the write pulse. For example, a write pulse may be intended to set the memory bit to a low resistance value, referred to as a 1. The memory bit may then be read to determine whether a 1 is present which may indicate that the memory bit has been set to the low resistance value. If the memory bit does not have the correct value, a subsequent voltage pulse may be sent to put the memory bit is in the correct value. However, such an operation may be time-consuming as at least a write operation and a read operation are needed for each attempt to write data, and in some cases may include a write operation, a read operation, and a subsequent write operation.

In another example, a feedback circuit may be included in the memory array to determine whether proper values are written to the memory bits. In this example, instead of a voltage pulse, a current ramp is implemented and the ramp is shut down when a particular resistance level of the memory bit is achieved. However, this approach may use additional circuitry which may be large and may take up valuable chip space. Additionally, the use of a feedback circuit in a crossbar array may be ineffective as the many parallel currents in a crossbar array may exhibit current leakage, making monitoring current through individual elements in the crossbar array very difficult.

Accordingly, the present disclosure describes systems and methods for re-initializing memory arrays. More specifically, the present disclosure allows for a reference state to be established for a memory array. Then, periodically, the memory array may be re-initialized to the reference state. In some examples, the memory array may be re-initialized during a period when no substantive data is stored in the memory array, such as during a gap period during a wear-leveling procedure. Re-initializing in this fashion may improve array lifetime and performance characteristics by leveraging and scheduling data movement during wear-leveling.

The present disclosure describes a method for re-initializing memory arrays. The method may include establishing a reference state for a memory array. The reference state may include target resistance values for the memory array. The method may also include writing data to the memory array. The method may also include re-initializing the memory array to the established reference state. The method may also include writing data to the re-initialized memory array.

The present disclosure describes a system for re-initializing memory arrays. The system may include a processor and a memory array communicatively coupled to the processor. The system may also include a memory manager. The memory manager may include an establish module to establish a reference state for the memory array. The reference state may include target resistance values for the memory array. The memory manager may also include a write module to write data to the memory array. The memory manager may also include a re-initialize module to re-initialize the memory array to the established reference state.

The present disclosure describes a computer program product for re-initializing memory arrays. The computer program product may include a computer readable storage medium. The computer program storage medium may include computer usable program code. The computer usable program code may include computer usable program code to, when executed by a processor, establish a reference state for a memory array. The computer usable program code may also include computer usable program code to, when executed by a processor, write data to the memory array. The computer usable program code may also include computer usable program code to, when executed by a processor, move the data from the memory array based on a wear leveling procedure. The computer usable program code may also include a computer usable program code to, when executed by a processor, re-initialize the memory array to the established reference state.

The systems and methods described herein may be beneficial by allowing a memory array to operate within a predetermined operating range. Additionally, variability in memory array resistance responses to voltage pulses may be reduced. Doing so may increase reliability and increase endurance of the memory array by maintaining the memory array within a predetermined operating range.

As used in the present specification and in the appended claims, the term “reference state” may refer to a predetermined state of a memory array. More specifically, when a memory array is in the “reference state” it may have multiple specified resistance values. For example, a memory array may have a target low resistance value and a target high resistance value.

Further, as used in the present specification and in the appended claims, the term “analog” may refer to a memory array that receives a pulse to change a resistance value of the memory bits within the memory array. For example, an analog memory array may include memory bits that are set to particular values via a voltage pulse. More specifically, a voltage pulse in one polarity may set a bit to a 1 value. By comparison, a voltage pulse in a different polarity may set a bit to a 0 value. A memristor array may be an example of an analog non-volatile memory array.

Still further, as used in the present specification and in the appended claims, the term “a number of” or similar language may include any positive number including 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

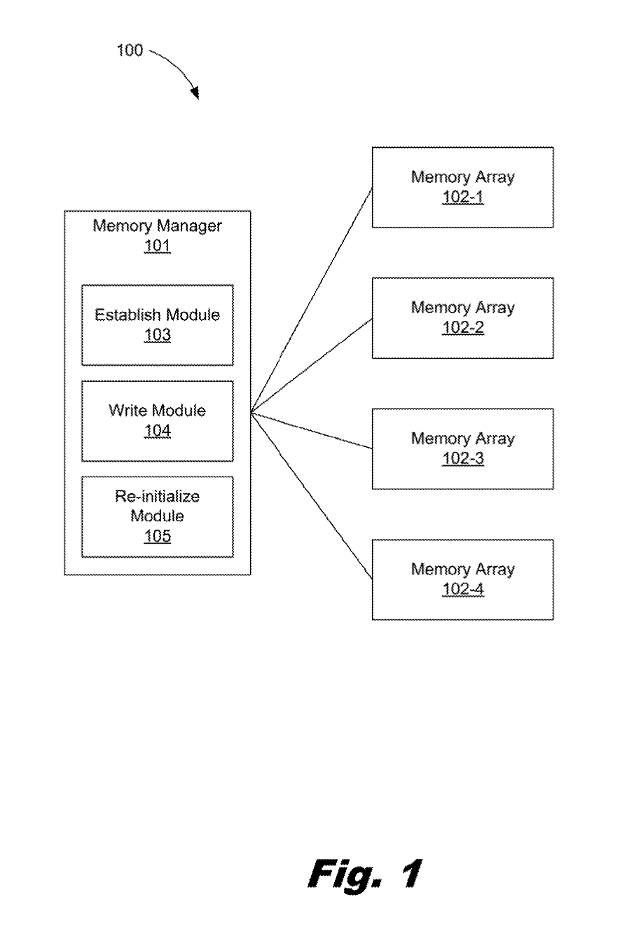

Turning now to the figures, FIG. 1 is a diagram of a system (100) for re-initializing memory arrays (102) according to one example of the principles described herein. In general, the system (100) may include memory arrays (102-1, 102-2, 102-3, 102-4). In some examples, the memory arrays (102) may be non-volatile memory arrays. A non-volatile memory array may refer to a memory array (102) that may maintain memory in the face of a loss of power. For example, if power is removed from a non-volatile memory array (102), data stored on the non-volatile memory array (102) may be accessed once power is again restored to the non-volatile memory array (102). In some examples, the non-volatile memory arrays (102) may be analog non-volatile memory arrays (102). An analog non-volatile memory array (102) may refer to a non-volatile memory array (102) that uses analog elements to store data. An analog element may store data by receiving a pulse that sets the analog element to a resistance value. A resistance state may correspond to a bit value that stores data. For example, a low resistance value of an analog element may indicate a 1 value for that element. By comparison, a high resistance value of an analog element may indicate a 0 value for that element.

In some examples, the memory arrays (102) may be memristor arrays. A memristor may be an electronic circuit element for which the present resistance depends on prior resistances. The resistance may depend on current that is passed through the element. For example, resistance may increase for one direction of current flow, and resistance may decrease for current flow in the opposite direction.

In some examples, the memory array may be a cross-bar memory array. A cross-bar memory array may include a first number of parallel wires and a second number of parallel wires, the second number being perpendicular to the first number. The first number and second number of wires are connected at their intersecting points via memory devices. In this example, memristors may be used as the memory devices to connect intersecting wires in the cross-bar memory array.

The system (100) may include a memory manager (101) that manages memory arrays (102). For example, the memory manager (101) may manage the read operations, the write operations, and other operations performed on multiple memory arrays (102).

The memory manager (101) may include an establish module (103) that establishes a reference state for the memory arrays (102). A reference state may refer to a predetermined state of the memory array (102). The reference state may include target resistance values within the memory arrays (102). For example, a first memory array (102-1) may include memory locations that include memory bits that may store data. The memory bits may be in a “reference state.” As described above, the reference state may include target resistance values. In the reference state, the memory array may be calibrated to target resistance values. For example, during operation resistance values may drift due to statistical variation and data patterns. Accordingly, the memory array may be reset to the reference state to calibrate the memory array to the target resistance values. In some examples, the reference state may indicate optimized resistance values to be used when data is loaded.

The target resistance values in the reference state may be consistent with intended resistance values to indicate a logical value of a memory bit, before value drift occurs. For example, a “high resistance value” may correspond to the logical value 0. By comparison, a “low resistance value” may correspond to the logical value 1.

The memory manager (101) may include a write module (104) to write data to the memory arrays (102). As described above, data may be written to an analog memory array (102), such as a memristor array, by sending voltage pulses to the memory arrays (102) that change a resistance value of memory bits within the memory arrays (102). For example, a particular pulse may be sent that sets a memory bit in a memory array (102) to a high resistance value while a different pulse may be sent that sets a memory bit in a memory array (102) to a low resistance value.

The memory manager (105) may include a re-initialize module (105) that re-initializes the memory array (102) to the established reference state. For example, as described above, after many write operations, the nature of an analog memory array (102) may be such that a statistical variation in the responses to write pulses may cause a drift in the resistance of the memory array (102). In this example, the memory manager (105) may re-initialize the memory arrays (102) to the reference state to compensate for the drift. Re-initializing may include reconditioning the memory bits so that the resistance values they exhibit after the application of a write pulse align with the target resistance values indicated in the reference state. For example, a reference state may specify a specific resistance value corresponds to the logical value 0. Over time the specific resistance value response to a voltage pulse may drift due to statistical variation and memory array (102) access patterns. In this example, the re-initialize module (105) may re-calibrate the memory array (102) such that the specific resistance value of memory bits again corresponds to the target resistance values. The re-initialize module (105) may then perform the same operation again to ensure the resistance value of a bit again is associated with the target resistance value.

While specific reference has been made to a re-initialization that includes a write operation, a read operation, or combinations thereof, the re-initialize module (105) may implement other procedures. For example, the memory manager (101) may perform a number of operations in which the memory manager (101) directs a memory die on which the—memory array (102) is located to perform a number of operations to re-initialize the memory array (102). In some examples, the number of operations to re-initialize the memory array (102) may be specific to the memory die on which the memory array (102) is located.

In some examples, the re-initialize module (105) may re-initialize the memory arrays (102) during a period when the memory array (102) does not store any data. For example, as will be described in detail below, a wear-leveling procedure may operate on the system (100) such that at certain periods of time, the first memory array (102-1) may be in a gap period in which no data is stored in the first memory array (102-1). During this period of time, the re-initialize module (105) may re-initialize the first memory array (102-1) to the reference state.

Implementing a re-initialize module (105) as described herein may be beneficial in that it improves reliability as periodically, the memory arrays (102) are set to an established reference state. Moreover, the system (100) described herein may alleviate the need for feedback circuitry, effectively saving chip space and reducing chip cost.

Additionally, re-initializing a memory array (102) during a gap period in a wear-leveling procedure may be beneficial in that it reduces the risk of data loss as the memory array (102) in a gap period does not hold any data. Moreover, synchronizing the re-initialization of a memory array (102) and a wear-leveling procedure may reduce overhead as multiple operations are performed at the same time.

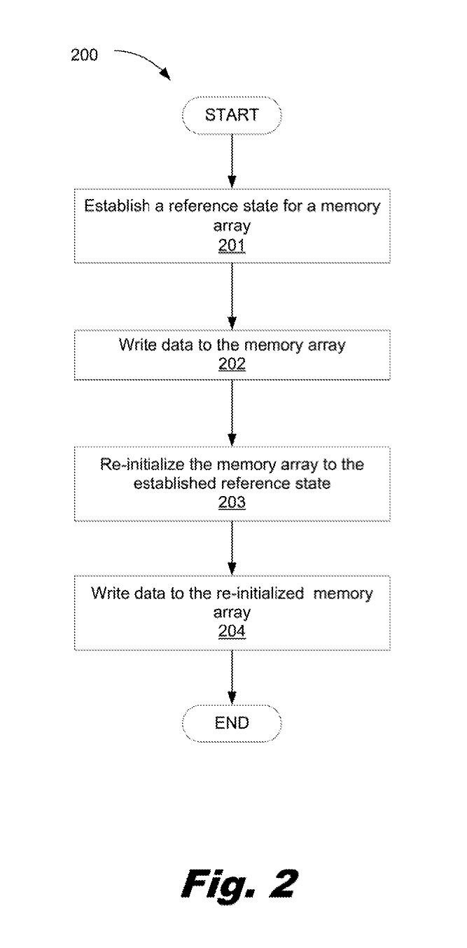

FIG. 2 is a flowchart of a method (200) for re-initializing memory arrays (FIG. 1, 102) according to one example of the principles described herein. The method (200) may include establishing (block 201) a reference state for a memory array (FIG. 1, 102). As described above, a reference state may refer to a predetermined control state of a memory array (FIG. 1, 102). For example, a reference state of the memory array (FIG. 1, 102) may refer to a state wherein a memory array is set to a number of target resistance values. The target resistance values may include any specified resistance value of memory bits within the memory array (FIG. 1, 102).

Establishing (block 201) a reference state for a memory array (FIG. 1, 102) may include setting the resistance values of memory bits within a memory array to a particular value, and then performing the operation a second time to ensure each memory bit within the memory array (FIG. 1, 102) is set to the proper value. For example, if the reference state of the memory array (FIG. 1, 102) is a state in which each memory bit within the memory array (FIG. 1, 102) includes a high resistance value, a voltage pulse may be sent that sets each memory bit to the high resistance value. A second similar voltage pulse may then be sent that ensures each memory bit is in the high resistance value. Establishing (block 201) a reference state may involve testing the resistive value of the memory bit, and sending a second voltage pulse to further adjust the memory bit until the target resistance value is established.

The method (200) may include writing (block 202) data to the memory array (FIG. 1, 102). As described above, writing (block 202) data to the memory array (FIG. 1, 102) may include sending voltage pulses to the memory bits within memory array (FIG. 1, 102) to change the resistance values of the memory bits. For example, a first voltage pulse may be sent to set a first memory bit to a high resistance value. Similarly a second voltage pulse may be sent to set a second memory bit to a low resistance value. Accordingly, writing (block 202) data to the memory array (FIG. 1, 102) may include sending voltage pulses to an analog memory array (FIG. 1, 102) such as a memristor array to set the memristors within the array to particular resistance values.

The method (200) may include re-initializing (block 203) the memory array (FIG. 1, 102) to the established reference state. As described above, in some examples memory arrays (FIG. 1, 102) may be subject to resistance drift. Accordingly, re-initializing (block 203) the memory array (FIG. 1, 102) may include resetting the state of the memory array (FIG. 1, 102) to a predetermined reference state.

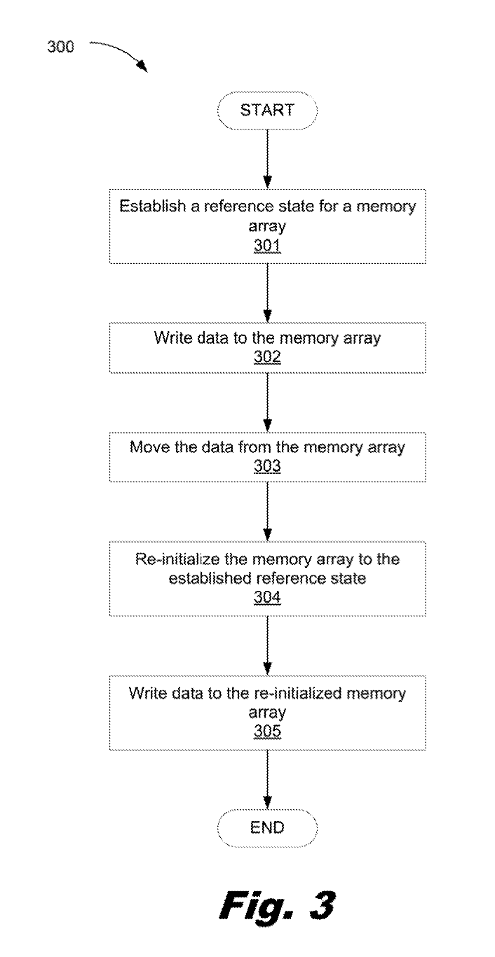

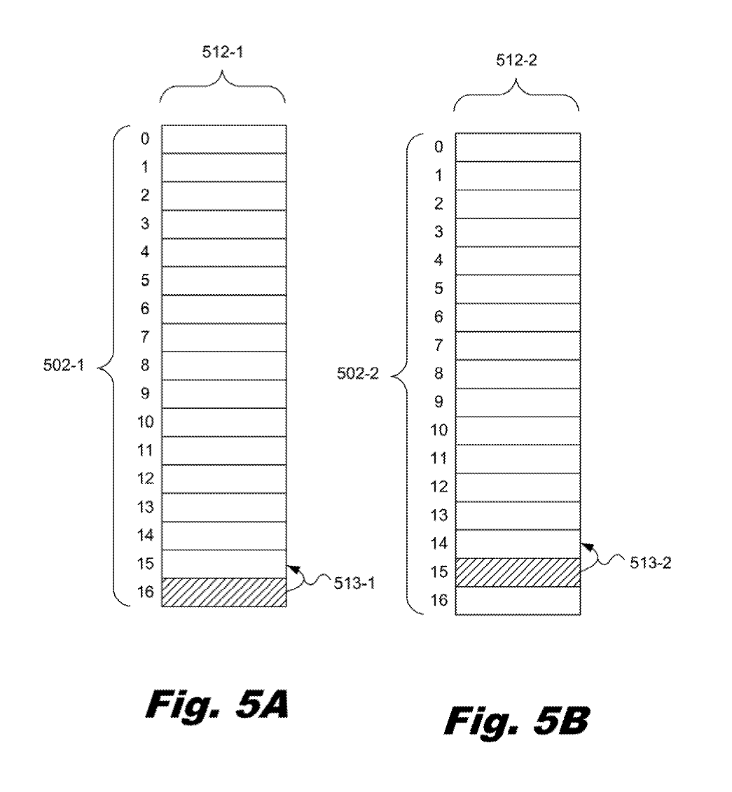

Re-initializing (block 203) the memory array (FIG. 1, 102) may include setting memory bits within a memory array (FIG. 1, 102) to a particular resistance value, for example a target resistance value, and then performing the operation a second time to ensure each memory bit within the memory array (FIG. 1, 102) is set to the proper resistance value. While specific reference is made to one form of re-initialization, any form of re-initialization may be used that resets a number of memory bits within a memory array (FIG. 1, 102) to a reference state. In some examples, the re-initialization may consider an “age” of the memory array (FIG. 1, 102). For example, the re-initialization may use a different procedure when a memory array (FIG. 1, 102) has been written to a certain number of times. As will be described in more detail below, the memory array (FIG. 1, 102) may be re-initialized during a gap period during a wear-leveling procedure, or rather when the memory array (FIG. 1, 102) does not have any data stored therein. More detail concerning the re-initialization during a gap period is given below in connection with FIGS. 3 and 5.

The method (200) may then include writing (block 204) data to the re-initialized memory array (FIG. 1, 102). As described above, writing (block 204) data to the memory array (FIG. 1, 102) may include sending voltage pulses to the memory bits within the memory array (FIG. 1, 102) to change the resistance values of the memory bits. For example, a first voltage pulse may be sent to set a first memory bit to a high resistance value. Similarly a second voltage pulse may be sent to set a second memory bit to a low resistance value. Accordingly, writing (block 204) data to the memory array (FIG. 1, 102) may include sending voltage pulses to an analog memory array (FIG. 1, 102) such as a memristor array to set the memristors within the array to particular resistance values. While specific reference is made to setting the resistance value of the memory bits using a voltage pulse, any other procedure to write the memory state may be implemented. Examples of other procedures include providing current, heating, or other memory element writing device.

Re-initializing a memory array (FIG. 1, 102) in this fashion may be beneficial in that it alleviates the need for a feedback circuit on the memory array (FIG. 1, 102). Accordingly, chip space is conserved and by extension, the cost to produce a chip is reduced. Moreover, as the memory array (FIG. 1, 102) is periodically re-initialized to a reference state, the memory array (FIG. 1, 102) is maintained in a defined operating range. Still further, by resetting the memory bits within a memory array (FIG. 1, 102) to a reference state, the likelihood of resistance drift is reduced by calibrating the memory bits to the reference state.

FIG. 3 is a flowchart of another method (300) for re-initializing memory arrays (FIG. 1, 102) according to one example of the principles described herein. The method (300) may include establishing (block 301) a reference state for a memory array (FIG. 1,102). This may be performed as described in connection with FIG. 2. The method (300) may include writing (block 302) data to the memory array (FIG. 1, 102). This may be performed as described in connection with FIG. 2.

In some examples, the data may be moved (block 303) from the memory array (FIG. 1, 102). As mentioned above, the re-initialization may occur when the memory array (FIG. 1, 102) does not include data; for example during a wear-leveling procedure. During a wear-leveling procedure data is moved between memory arrays (FIG. 1, 102). More specifically, in some instances certain memory arrays (FIG. 1, 102) may receive a disproportionate amount of activity. This may lead to some non-volatile memory arrays (FIG. 1, 102) failing before the system's (FIG. 1, 100) expected lifetime. In a wear-leveling procedure, data is moved between memory arrays (FIG. 1, 102) to ensure that memory arrays (FIG. 1, 102) within a memory system (FIG. 1, 100) receive approximately equal activity rather than having some memory arrays (FIG. 1, 102) receiving a disproportionate amount of activity.

Accordingly, data may be moved from one memory array (FIG. 1, 102), such as a first memory array (FIG. 1, 102-1), to another memory array (FIG. 1, 102), such as a second memory array (FIG. 1, 102-2). After the data is moved from the first memory array (FIG. 1, 102-1) to the second memory array (FIG. 1, 102-2), the first memory array (FIG. 1, 102-1) may not be storing any data. It is during this period when the first memory array (FIG. 1, 102-1) is unoccupied that the first memory array (FIG. 1, 102-1) may be re-initialized. Re-initializing during a period when the first memory array (FIG. 1, 102-1) does not hold data may be beneficial in that it re-initializes the memory array (FIG. 1, 102) at a time when data will not be lost during re-initialization. In other words, re-initializing when a memory array (FIG. 1, 102) is in a gap period of the wear-leveling procedure may alleviate a need to have additional data safeguards during re-initialization.

The method (300) may include re-initializing (block 304) the memory array (FIG. 1, 102) to the established reference state. Re-initializing (block 304) the memory array (FIG. 1, 102) may be performed by the memory manager (FIG. 1, 101). For example, the memory manager (FIG. 1, 101) may perform a write operation, a read operation, or combinations thereof on the memory array (FIG. 1, 102). For example, the memory manager (FIG. 1, 101) may send a voltage pulse to set the memory bits within the memory array (FIG. 1, 102) to a certain target resistance value, which target resistance value may be defined by the reference state. The memory manager (FIG. 1, 101) may then send a similar voltage pulse to again set the memory bits within the memory array (FIG. 1, 102) to a similar resistance value. Sending multiple write pulses may be beneficial in that it ensures that a greater number of memory bits within the memory array (FIG. 1, 102) have been reset to the reference state.

Re-initializing (block 304) the memory array (FIG. 1, 102) may be performed at the memory die associated with the memory array (FIG. 1, 102) to perform a re-initialization transaction. For example, a memory array (FIG. 1, 102) may be positioned on a memory die. In this example, the memory die itself may orchestrate the sequence to re-initialize the memory array (FIG. 1, 102). In some examples, the re-initialization transaction performed by the memory die may be based on the characteristics of the memory die. Examples of characteristics include a type of memory array (FIG. 1, 102), an age of the memory array (FIG. 1, 102), a quantity of memory arrays (FIG. 1, 102) on the memory die, among other memory die characteristics. For example, the first memory die may include a first sequence of re-initialization operations for the first memory array (102-1) that may be tailored for the first memory array (102-1). Similarly, a second memory die may include a second sequence of re-initialization operations for the second memory array (102-2) that may be tailored for the second memory array (102-2). In this example, the first sequence of re-initialization operations may be different from the second sequence of re-initialization operations.

The method (300) may include writing (block 305) data to the re-initialized memory array (FIG. 1, 102). This may be performed as described in connection with FIG. 2.

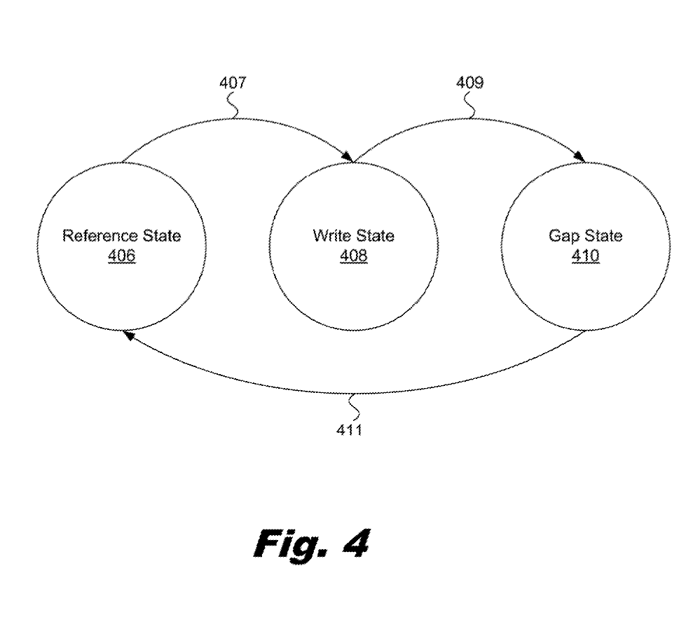

FIG. 4 is a state diagram illustrating states of a memory array (FIG. 1, 102) according to one example of the principles described herein. Initially, the memory array (FIG. 1, 102) may be in a reference state (406). In the reference state (406) each memory bit within a memory array (FIG. 1, 102) may be set to a predetermined value, or target resistance value. As described above, data may be written to the memory array (FIG. 1, 102). Accordingly, the memory array (FIG. 1, 102) enters a write state (408) as indicated by the arrow (407). The write state (408) may refer to a state where the memory bits within a memory array (FIG. 1, 102) receive voltage pulses of differing polarities to set the bits to different values.

As described above, in some examples, a wear-leveling procedure may be implemented in the memory system (FIG. 1, 100). Accordingly data in the memory array (FIG. 1, 102) may be moved to memory array (FIG. 1, 102). For example, data may be moved from a first memory array (FIG. 1, 102-1) to a second memory array (FIG. 1, 102-2). In this example, the first memory array (FIG. 1, 102-1) may be unoccupied. In other words, the first memory array (FIG. 1, 102-1) may enter into a gap state (410) as indicated by the arrow (409). As used herein a gap state (410) may refer to a state in which a memory is in a gap location and in which no data is stored in the memory array (FIG. 1, 102). More detail concerning the gap state (410) is given in connection with FIG. 5. After data has been moved from the memory array (FIG. 1, 102) and the memory array (FIG. 1, 102) is in a gap state (410), the memory array (FIG. 1, 102-1) may be re-initialized to the reference state (406) as indicated by the arrow (411). Resetting the memory array (FIG. 1, 102) to the reference state (406) may be beneficial in that each bit is calibrated to a determined resistance value periodically which may reduce a drift that may occur over time due to statistical variations in responses to voltage pulses received.

FIGS. 5A and 5B are diagrams of a system for re-initializing memory arrays (502) according to one example of the principles described herein. Memory (512) may be divided into a number of memory arrays (502). In FIGS. 5A and 5B each memory array (502) may be indicated by an index number 0-16.

As described above, a wear-leveling procedure may make writes to memory (512) more uniform by remapping heavily written memory arrays (502) to less frequently written memory arrays (502). More specifically, during wear-leveling, data may be periodically moved from one memory array (502) to another memory array (502). A specific example of wear-leveling is given as follows. In FIG. 5A, a memory array (502) of the memory (512) may be designated as a gap location. For example, in the first memory (512-1) the memory array (502-2) indicated by the index number 16 may be the gap location as indicated by the cross-hatch. A gap location may refer to a memory array (502-1) that does not hold data. It is when a memory array (502-1) does not include information, or it is the gap location, that the memory array (502-1) may be re-initialized as described herein.

During wear-leveling, the gap location may be moved to a new memory array (502). For example, the gap location may be moved from index 16 to index 15 as indicated by the arrow (513-1). Accordingly, the memory array (502-2) at index 15 may be the new gap location as indicated by the cross-hatch in FIG. 5B. The movement of the gap location is accomplished by copying the data from one memory array (502) to another memory array (502). For example, the data may be moved from memory array (502) 15 to memory array (502) 16.

In this example, as the gap location indicated by the cross-hatch now corresponds to index 15, the memory array (502-2) indicated by the index 15 may be re-initialized as described herein. The gap location may then be moved to another memory array (502) such as the memory array (502) indicated by the index 14 as indicated by the arrow (513-2). In some examples, the gap location may be moved after a particular number of writes have been performed on the memory (512), after a predetermined period of time, or combinations thereof.

In one example, a wear-leveling procedure may periodically move data from one memory array to another memory array. For example, by moving data from one memory array to an adjacent memory array.

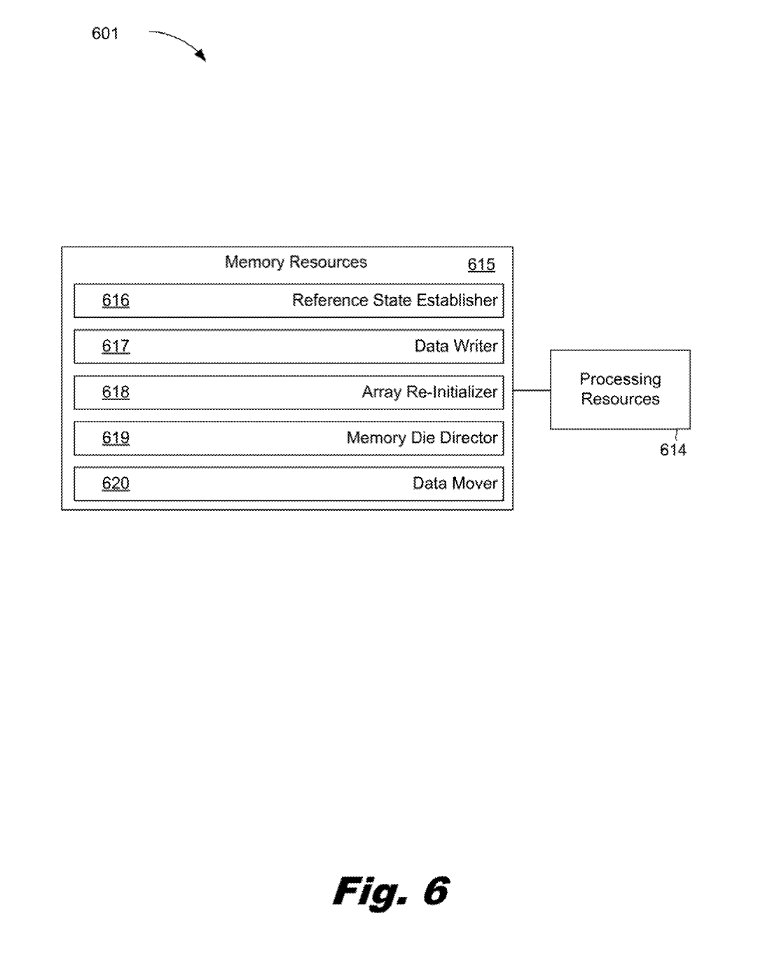

FIG. 6 is a diagram of a memory manager (601) for re-initializing memory arrays (FIG. 1, 102) according to one example of the principles described herein. The memory manager (601) may include the hardware architecture to retrieve executable code and execute the executable code. The executable code may, when executed by the memory manager (601), cause the memory manager (601) to implement at least the functionality of re-initializing memory arrays (FIG. 1, 102), according to the methods of the present specification described herein. In the course of executing code, the memory manager (601) may receive input from and provide output to the remaining hardware units.

In this example, the memory manager (601) may include processing resources (614) that are in communication with memory resources (615). Processing resources (614) may include at least one processor and other resources used to process programmed instructions. The memory resources (615) represent generally any memory capable of storing data such as programmed instructions or data structures used by the memory manager (601). The programmed instructions shown stored in the memory resources (615) may include a reference state establisher (616), a data writer (617), an array re-initializer (618), a memory die director (619), and a data mover (620).

The memory resources (615) include a computer readable storage medium that contains computer readable program code to cause tasks to be executed by the processing resources (614). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The reference state establisher (616) represents programmed instructions that, when executed, cause the processing resources (614) to establish a reference state for a memory array (FIG. 1, 102). The reference state establisher (616) may be implemented by the establish module (FIG. 1, 103). The data writer (617) represents programmed instructions that, when executed, cause the processing resources (614) to write data to the memory array (FIG. 1, 102) and the re-initialized memory array (FIG. 1, 102). The data writer (617) may be implemented by the write module (FIG. 1, 104). The array re-initializer (618) represents programmed instructions that, when executed, cause the processing resources (614) to re-initialize the array to the established reference state. The array re-initializer (618) may be implemented by the re-initialize module (FIG. 1, 104). The memory die director (619) represents programmed instructions that, when executed, cause the processing resources (614) to direct a memory die associated with the memory array (FIG. 1, 102) to perform a re-initialization transaction. The data mover (620) represents programmed instructions that, when executed, cause the processing resources (614) to move the data from the memory array (FIG. 1, 102) before re-initializing the memory array (FIG. 1, 102).

Further, the memory resources (615) may be part of an installation package. In response to installing the installation package, the programmed instructions of the memory resources (615) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (614) and the memory resources (615) are located within the same physical component, such as a server, or a network component. The memory resources (615) may be part of the physical component's main memory, caches, registers, non-volatile memory, or elsewhere in the physical component's memory hierarchy. Alternatively, the memory resources (615) may be in communication with the processing resources (614) over a network. Further, the data structures, such as the libraries, may be accessed from a remote location over a network connection while the programmed instructions are located locally. Thus, the memory manager (601) may be implemented on a user device, on a server, on a collection of servers, or combinations thereof.

Methods and systems for re-initializing memory arrays (FIG. 1, 102) may have a number of advantages, including: (1) improving memory array (FIG. 1, 102) lifetime; (2) improving the consistency of read and write times; (3) constraining worst-case power consumption; (4) synchronizing wear-leveling and re-initialization to balance overhead; (5) taking advantage of cycles when each memory array is unoccupied to re-initialize; and (6) reducing bit error rates.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processing resources (614) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The preceding description has been presented to illustrate and describe examples of the principles described. This description is not intended to be exhaustive or to limit these principles to any precise form disclosed. Many modifications and variations are possible in light of the above teaching.

What is claimed is:

1. A system for re-initializing a memory array, comprising:
a processor;
a memory array communicatively coupled to the processor; and
a memory manager, the memory manager comprising:
an establish module to establish a reference state for the memory array, in which the reference state comprises a number of target resistance values for the memory array;
a write module to write data to the memory array; and
a re-initialize module to re-initialize the memory array to the established reference state.

2. The system of claim 1, in which the memory array is an analog memory array.

3. The system of claim 1, in which the memory array is a memristor memory array.

4. The system of claim 1, in which the memory array is a cross-bar memory array.

5. The system of claim 1, in which the re-initialize module re-initializes the memory array during a gap period in a wear-level procedure.

6. A method for re-initializing a memory array, comprising:
establishing a reference state for a memory array, in which the reference state comprises a number of target resistance values for the memory array;
writing data to the memory array;
re-initializing the memory array to the established reference state; and
writing data to the re-initialized memory array.

7. The method of claim 6, in which the memory array comprises a memristor memory array.

8. The method of claim 6, in which re-initializing the memory array comprises directing a memory die associated with the memory array to perform a number of re-initialization operations.

9. The method of claim 8, in which the number of re-initialization operations are based on characteristics of the memory die.

10. The method of claim 6, in which re-initializing the memory array comprises performing, via a memory manager, a write operation, a read operation, or combinations thereof on the memory array.

11. The method of claim 6, further comprising moving the data from the memory array before re-initializing the memory array.

12. The method of claim 11, in which the data is moved to an adjacent memory array.

13. The method of claim 6, in which the reference state is a high resistance state.

14. A computer program product for re-initializing a memory array, the computer program product comprising:
a computer readable storage medium comprising computer usable program code embodied therewith, the computer usable program code comprising:
computer usable program code to, when executed by a processor, establish a reference state for a memory array;
computer usable program code to, when executed by a processor, write data to the memory array;
computer usable program code to, when executed by a processor, move the data from the memory array based on a wear leveling procedure; and
computer usable program code to, when executed by a processor, re-initialize the memory array to the established reference state.

15. The product of claim 14, in which the memory array is a non-volatile memory array.
